(19) United States
(12) Patent Application Publication
(10) Pub. No.: US 2025/0192868 A1
(43) Pub. Date: Jun. 12, 2025

(54) NETWORK CONTROLLED USER EQUIPMENT FEEDBACK OF MODEL INFERENCE ERROR OF NETWORK NODE BEAM PREDICTIONS

(71) Applicant: QUALCOMM Incorporated, San Diego, CA (US)

(72) Inventors: Qiaoyu LI, Beijing (CN); Taesang YOO, San Diego, CA (US); Tianyang BAI, Mountain View, CA (US); Arumugam CHENDAMARAI KANNAN, San Diego, CA (US); Mahmoud TAHERZADEH BOROUJENI, San Diego, CA (US); Hamed PEZESHKI, San Diego, CA (US); Hua WANG, Basking Ridge, NJ (US); Tao LUO, San Diego, CA (US)

(21) Appl. No.: 18/842,328

(22) PCT Filed: May 7, 2022
(86) PCT No.: PCT/CN2022/091432

§ 371 Date: Aug. 28, 2024

(51) Int. Cl. H04B 7/06

(52) U.S. Cl. CPC H04B 7/06968; H04B 7/0626

(57) ABSTRACT

Various aspects of the present disclosure generally relate to wireless communication. In some aspects, a user equipment (UE) may obtain a trigger condition associated with reporting a difference between a quality of a downlink reference signal and a quality of a Type-D quasi co-located (QCL) source reference signal associated with a physical downlink shared control channel (PDSCH). The UE may transmit, to a network node, a detection indication associated with detecting the trigger condition. Numerous other aspects are described.

### FIELD OF THE DISCLOSURE

Aspects of the present disclosure generally relate to wireless communication and to techniques and apparatuses for network controlled user equipment feedback of model inference error of network entity beam predictions.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include obtaining a trigger condition associated with reporting a difference between a quality of a downlink reference signal and a quality of a Type-D quasi co-located (QCL) source reference signal associated with a physical downlink shared control channel (PDSCH). The method may include transmitting, to a network node, a detection indication associated with detecting the trigger condition.

Some aspects described herein relate to a method of wireless communication performed by a network node. The method may include transmitting a trigger condition associated with reporting a difference between a quality of a downlink reference signal and a quality of a Type-D QCL source reference signal associated with a PDSCH. The method may include receiving a detection indication associated with detecting the trigger condition.

Some aspects described herein relate to an apparatus for wireless communication at a UE. The apparatus may include a memory and one or more processors coupled to the memory. The one or more processors may be configured to obtain a trigger condition associated with reporting a difference between a quality of a downlink reference signal and a quality of a Type-D QCL source reference signal associated with a PDSCH. The one or more processors may be configured to transmit, to a network node, a detection indication associated with detecting the trigger condition.

Some aspects described herein relate to an apparatus for wireless communication at a network node. The apparatus may include a memory and one or more processors coupled to the memory. The one or more processors may be configured to transmit a trigger condition associated with reporting a difference between a quality of a downlink reference signal and a quality of a Type-D QCL source reference signal associated with a PDSCH. The one or more processors may be configured to receive a detection indication associated with detecting the trigger condition.

Some aspects described herein relate to a non-transitory computer-readable medium that stores a set of instructions for wireless communication by a UE. The set of instructions, when executed by one or more processors of the UE, may cause the UE to obtain a trigger condition associated with reporting a difference between a quality of a downlink reference signal and a quality of a Type-D QCL source reference signal associated with a PDSCH. The set of instructions, when executed by one or more processors of the UE, may cause the UE to transmit, to a network node, a detection indication associated with detecting the trigger condition.

Some aspects described herein relate to a non-transitory computer-readable medium that stores a set of instructions for wireless communication by a network node. The set of instructions, when executed by one or more processors of the network node, may cause the network node to transmit a trigger condition associated with reporting a difference between a quality of a downlink reference signal and a quality of a Type-D QCL source reference signal associated with a PDSCH. The set of instructions, when executed by one or more processors of the network node, may cause the network node to receive a detection indication associated with detecting the trigger condition.

Some aspects described herein relate to an apparatus for wireless communication. The apparatus may include means for obtaining a trigger condition associated with reporting a difference between a quality of a downlink reference signal and a quality of a Type-D QCL source reference signal associated with a PDSCH. The apparatus may include means for transmitting, to a network node, a detection indication associated with detecting the trigger condition.

Some aspects described herein relate to an apparatus for wireless communication. The apparatus may include means for transmitting a trigger condition associated with reporting a difference between a quality of a downlink reference signal and a quality of a Type-D QCL source reference signal associated with a PDSCH. The apparatus may include means for receiving a detection indication associated with detecting the trigger condition.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating examples of beam management procedures, in accordance with the present disclosure.

FIG. 4 is a diagram illustrating an example of a beam prediction procedure, in accordance with the present disclosure.

FIG. 5 is a diagram illustrating an example of a wireless communication process that may be performed, at least in part, by a UE and a network node in a wireless communication network, in accordance with the present disclosure.

FIGS. 6A and 6B are diagrams illustrating a first example and a second example of detecting a difference in quality based at least in part on a trigger condition, in accordance with the present disclosure.

FIG. 7 is a diagram illustrating an example process performed, for example, by a UE, in accordance with the present disclosure.

FIG. 8 is a diagram illustrating an example process performed, for example, by a network node, in accordance with the present disclosure.

FIG. 9 is a diagram of a first example apparatus for wireless communication, in accordance with the present disclosure.

FIG. 10 is a diagram of a second example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

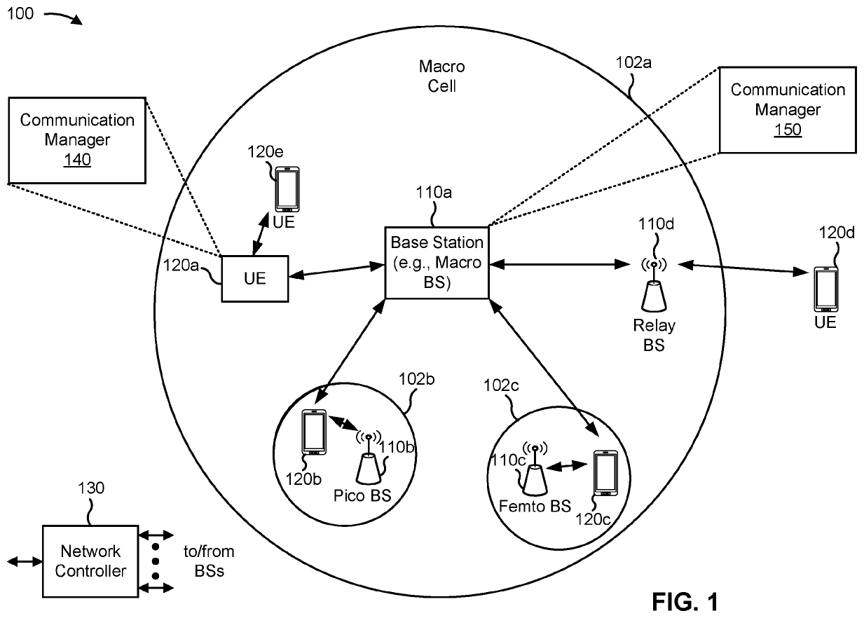

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

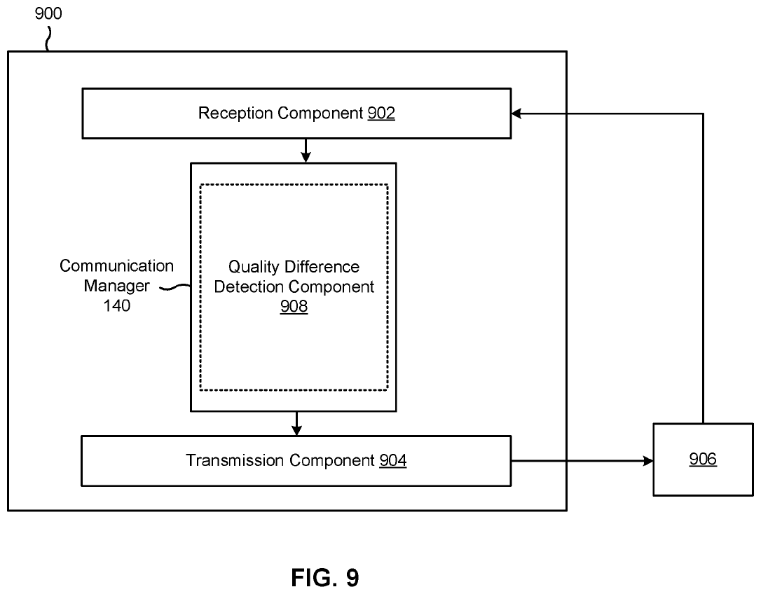

In some aspects, the term “base station” (e.g., the base station 110) or “network node” or “network entity” may refer to an aggregated base station, a disaggregated base station (e.g., described in connection with FIG. 9), an integrated access and backhaul (IAB) node, a relay node, and/or one or more components thereof. For example, in some aspects, “base station,” “network node,” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station,” “network node,” or “network entity” may refer to one device configured to perform one or more functions, such as those described herein in connection with the base station 110. In some aspects, the term “base station,” “network node,” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station,” “network node,” or “network entity” may refer to any one or more of those different devices. In some aspects, the term “base station,” “network node,” or “network entity” may refer to one or more virtual base stations and/or one or more virtual base station functions. For example, in some aspects, two or more base station functions may be instantiated on a single device. In some aspects, the term “base station,” “network node,” or “network entity” may refer to one of the base station functions and not another. In this way, a single device may include more than one base station.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may obtain a trigger condition associated with reporting a difference between a quality of a downlink reference signal and a quality of a Type-D QCL source reference signal associated with a PDSCH. The communication manager 140 may transmit, to a network node, a detection indication associated with detecting the trigger condition. Additionally, or alternatively, the communication manager 140 may perform one or more other operations described herein.

In some aspects, a network node may include a communication manager 150. As described in more detail elsewhere herein, the communication manager 150 may transmit a trigger condition associated with reporting a difference between a quality of a downlink reference signal and a quality of a Type-D QCL source reference signal associated with a PDSCH. The communication manager 150 may receive a detection indication associated with detecting the trigger condition. Additionally, or alternatively, the communication manager 150 may perform one or more other operations described herein.

As indicated above, FIG. 1 is provided as an example. Other examples may differ from what is described with regard to FIG. 1.

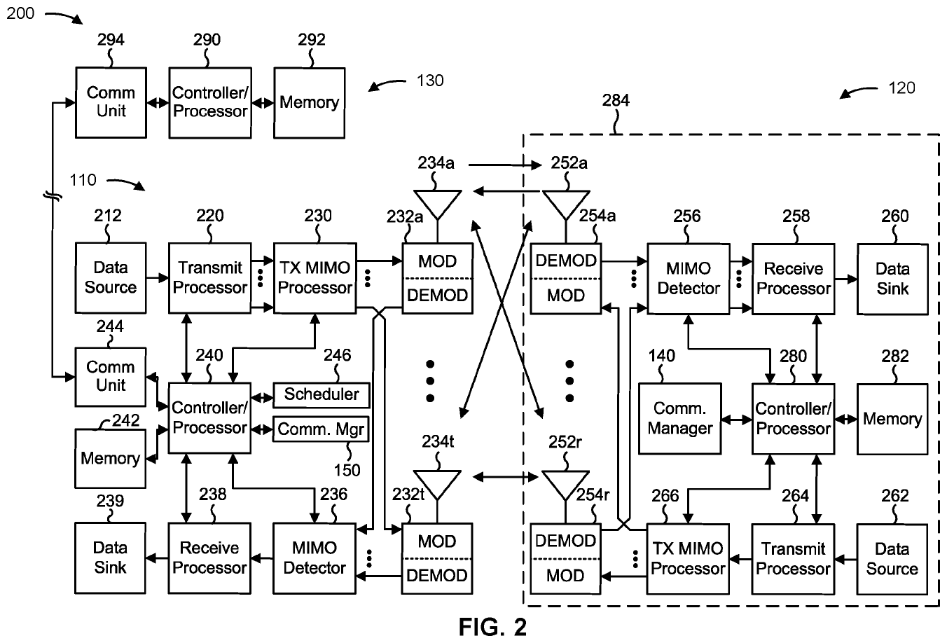

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

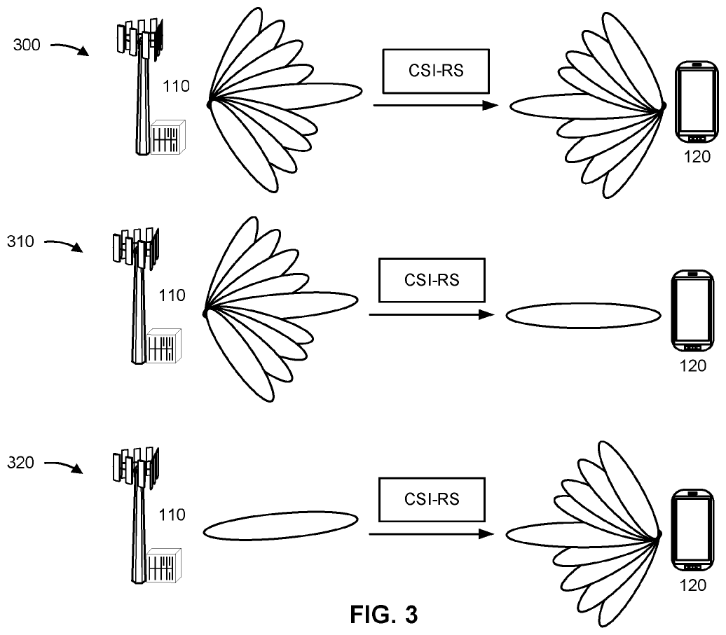

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-10).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-10).

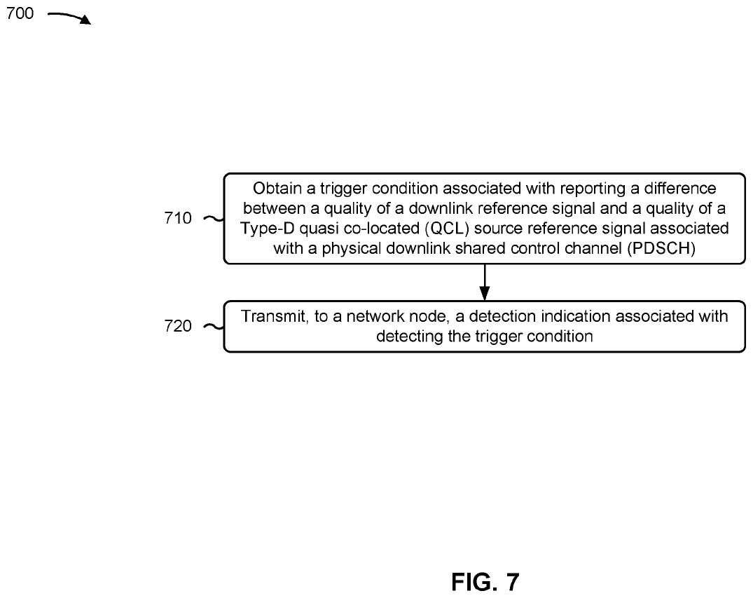

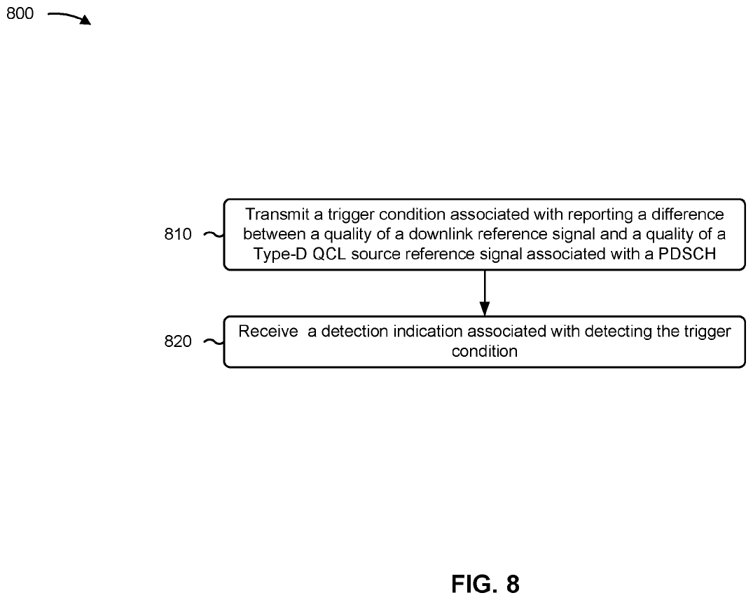

The controller/processor 240 of the base station 110, the controller/processor 280 of the UE 120, and/or any other component(s) of FIG. 2 may perform one or more techniques associated with network controlled user equipment feedback of model inference error of network entity beam predictions, as described in more detail elsewhere herein. For example, the controller/processor 240 of the base station 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, a UE (e.g., the UE 120) includes means for obtaining a trigger condition associated with reporting a difference between a quality of a downlink reference signal and a quality of a Type-D QCL source reference signal associated with a PDSCH, and/or means for transmitting, to a network node, a detection indication associated with detecting the trigger condition. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node includes means for transmitting a trigger condition associated with reporting a difference between a quality of a downlink reference signal and a quality of a Type-D QCL source reference signal associated with a PDSCH, and/or means for receiving a detection indication associated with detecting the trigger condition. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

FIG. 3 is a diagram illustrating examples 300, 310, and 320 of CSI-RS beam management procedures, in accordance with the present disclosure. As shown in FIG. 3, examples 300, 310, and 320 include a UE 120 in communication with a network node (shown as a base station 110) in a wireless network (e.g., wireless network 100). However, the devices shown in FIG. 3 are provided as examples, and the wireless network may support communication and beam management between other devices (e.g., between a UE 120 and a base station 110 or transmit receive point (TRP), between a mobile termination node and a control node, between an integrated access and backhaul (IAB) child node and an IAB parent node, and/or between a scheduled node and a scheduling node). Other examples may include alternate or additional network nodes in communication with the UE, such as a radio unit, a distributed unit, and/or a central unit of a distributed base station. In some aspects, the UE 120 and the base station 110 may be in a connected state (e.g., a radio resource control (RRC) connected state).

As shown in FIG. 3, example 300 may include a base station 110 and a UE 120 communicating to perform beam management using one or more reference signals, shown in the example 300 as channel state information (CSI)-reference signals (CSI-RSs). Example 300 depicts a first beam management procedure. The first beam management procedure may be referred to as a P1 CSI-RS beam management procedure, a beam selection procedure, an initial beam acquisition procedure, a beam sweeping procedure, a cell search procedure, and/or a beam search procedure. In some aspects, the beam management procedure may be based at least in part on one or more synchronization signal blocks (SSBs) that includes a PSS or SSS. As shown in FIG. 3 and example 300, CSI-RSs may be configured to be transmitted from the base station 110 to the UE 120. The CSI-RSs may be configured to be periodic (e.g., using RRC signaling), semi-persistent (e.g., using media access control (MAC) control element (CE) signaling), and/or aperiodic (e.g., using downlink control information (DCI)). Other examples of beam management procedures may include uplink beam management procedures that use sounding reference signals (SRS) transmitted by the UE 120, such as a U1 beam management procedure (e.g., an initial selection of an uplink beam by a network entity or the UE), a U2 beam management procedure (e.g., a refinement of the uplink beam by the network entity), and/or a U3 beam management procedure (e.g., a refinement of the uplink beam by the UE).

The first beam management procedure may include the base station 110 performing beam sweeping over multiple transmit (Tx) beams. The base station 110 may transmit a CSI-RS using each transmit beam for beam management. To enable the UE 120 to perform receive (Rx) beam sweeping, the base station may use a transmit beam to transmit (e.g., with repetitions) each CSI-RS at multiple times within the same RS resource set so that the UE 120 can sweep through receive beams in multiple transmission instances. For example, if the base station 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the base station 110, the UE 120 may perform beam sweeping through the receive beams of the UE 120. As a result, the first beam management procedure may enable the UE 120 to measure a CSI-RS on different transmit beams using different receive beams to support selection of base station 110 transmit beams/UE 120 receive beam(s) beam pair(s). The UE 120 may report the measurements to the base station 110 to enable the base station 110 to select one or more beam pair(s) for communication between the base station 110.

Example 310 depicts a second beam management procedure (e.g., P2 CSI-RS beam management) that may be referred to as a beam refinement procedure, a base station beam refinement procedure, a TRP beam refinement procedure, and/or a transmit beam refinement procedure. As shown in FIG. 3 and example 310, CSI-RSs may be configured to be transmitted from the base station 110 to the UE 120. The CSI-RSs may be configured to be aperiodic (e.g., using DCI). The second beam management procedure may include the base station 110 performing beam sweeping over one or more transmit beams. The one or more transmit beams may be a subset of all transmit beams associated with the base station 110 (e.g., determined based at least in part on measurements reported by the UE 120 in connection with the first beam management procedure). The base station 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the base station 110 to select a best transmit beam based at least in part on measurements of the CSI-RSs (e.g., measured by the UE 120 using the single receive beam) reported by the UE 120.

As shown in FIG. 3, example 320 depicts a third beam management procedure (e.g., P3 CSI-RS beam management) that may be referred to as a beam refinement procedure, a UE beam refinement procedure, and/or a receive beam refinement procedure. In some aspects, one or more CSI-RSs may be configured to be transmitted from the base station 110 to the UE 120. The CSI-RSs may be configured to be aperiodic (e.g., using DCI). The third beam management process may include the base station 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the base station may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the base station 110 and/or the UE 120 to select a best receive beam based at least in part on reported measurements received from the UE 120 (e.g., of the CSI-RS of the transmit beam using the one or more receive beams).

As indicated above, FIG. 3 is provided as an example. Other examples may differ from what is described with regard to FIG. 3.

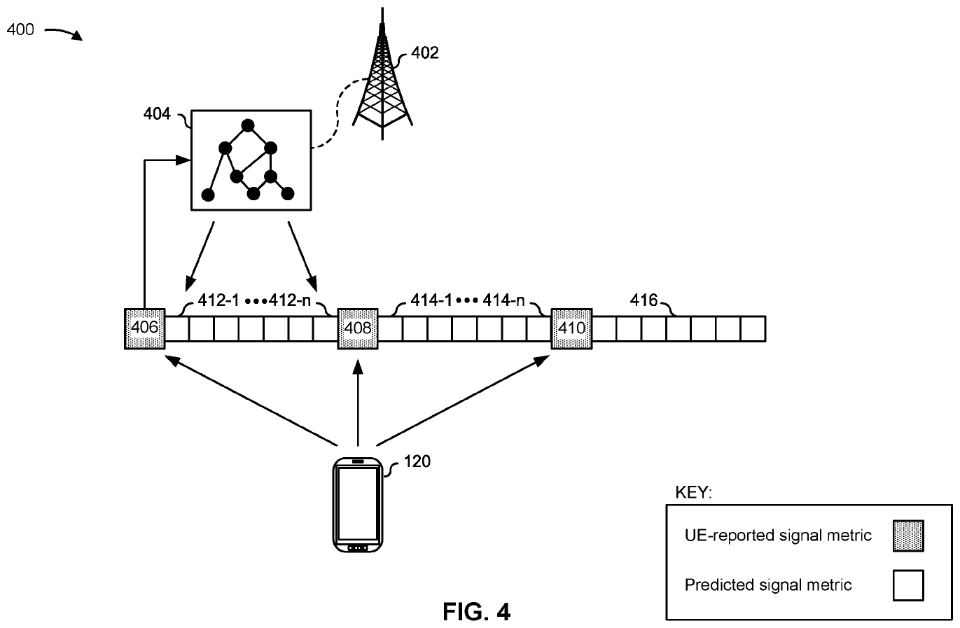

FIG. 4 is a diagram illustrating an example 400 of a beam prediction procedure, in accordance with the present disclosure.

Beam management procedures may improve communications in a wireless network by providing a network node and/or a UE with a mechanism to identify beams with better signal quality relative to other beams. Communicating via the wireless network using beams with better signal quality may reduce recovery errors at a receiver, increase data throughput, and/or reduce data-transfer latencies (e.g., by reducing retransmissions) relative to the other beams. Various factors may cause the network node and UE to perform the beam management procedures multiple times, such as atmospheric changes, the UE moving to a new location, and/or changes in interference associated with other devices. The repeated beam management procedures may consume air interface resources (e.g., frequency resources and/or time resources) that the wireless network could otherwise direct to additional devices or use for other transmissions. Thus, the repeated beam management procedures may increase data-transfer latencies for other devices while the network node and the UE perform each beam management procedure.

To reduce signaling overhead and resource consumption associated with beam management procedures, a network node 402 (shown in the example 400 as a base station) may select a beam and/or beam pairs based at least in part on prediction algorithms. For example, the network node 402 may include one or more modules 404 that are trained using a machine learning algorithm (e.g., a deep neural network (DNN) algorithm, a long short-term memory (LSTM) network algorithm, a gradient boosted algorithm, a K-means algorithm, and/or a random forest algorithm). Machine learning involves computers learning from data to perform tasks. As one example, machine learning algorithms are used to train machine learning models based at least in part on sample data, known as “training data.” Once trained, machine learning models may be used to make predictions, decisions, or classifications relating to new observations. In some aspects, the module(s) 404 may be trained to predict a signal metric (e.g., a signal-to-interference-plus-noise ratio (SINR) metric and/or an RSRP metric). Alternatively or additionally, the module(s) 404 may be trained to predict a beam and/or beam pair based at least in part on a signal metric (e.g., a UE-generated signal metric and/or a predicted signal metric).

To illustrate, the network node 402 may periodically receive a UE-reported signal metric (e.g., from the UE 120), as shown by reference number 406, reference number 408, and reference number 410. As one example, the network node 402 may receive, as a UE-reported signal metric, a layer 1 RSRP (L1-RSRP) metric and/or a layer 1 SINR (L1-SINR) metric from the UE 120 every 120 milliseconds (msec). The module(s) 404 may receive the UE-reported signal metric as input, and predict one or more signal metrics and/or one or more beam configurations at various points in time as shown by reference number 412-1 to reference number 412-n (where n is an integer). For instance, the module(s) 404 may use the UE-reported signal metric shown by reference number 406 to predict a set of future signal metrics and/or a set of future beam configurations at a periodicity of 20 msec. The module(s) 404 may iteratively receive UE-reported signal metrics as shown by reference number 408 and reference number 410 as feedback for subsequent predictions. To illustrate, the module(s) 404 may use the UE-reported signal metric shown by reference number 408 and/or the UE-reported signal metric shown by reference number 406 to predict signal metrics as shown by reference number 414-1 to reference number 414-n. The module(s) 404 may alternatively or additionally select a beam and/or beam pair that is predicted to have better performance (e.g., improved signal quality, reduced recovery errors, and/or increased data throughput) relative to other beams. To preserve air interface resources, the UE 120 may be configured to refrain from reporting a signal metric in between the configured reporting periods, as shown by reference number 406, reference number 408, and reference number 410.

At times, a trained prediction model and/or algorithm (e.g., the module(s) 404) may have model inference error. Model inference error may denote a machine learning model making an erroneous prediction and/or selection based at least in part on an available ground truth (e.g., data and/or feedback). As one example of a model inference error, the module(s) 404 may predict a signal metric for a beam that deviates from a UE-generated signal metric for the beam by a threshold value. As another example, the module(s) 404 may select a future beam that has reduced performance relative to another beam observed by the UE. To illustrate, the network node 402 may indicate transmission configuration indicator (TCI) state information to the UE 120 in downlink-grant (DL-grant) DCI, where the TCI state information is based at least in part on a predicted beam at a time duration as shown by reference number 416. In some aspects, the TCI state information may indicate one or more characteristics about at least two associated beams, such as a quasi co-located (QCL) beam that is associated with a predicted beam. “QCL beam” may denote a second beam that may have common properties with and/or a common transmission environment as a first beam, such as Doppler spread, Doppler shift, average delay, average gain, and/or a spatial parameter. Thus, for QCL beams, a channel property identified from a signal metric generated based at least in part on a first beam may be applied and/or assumed for a QCL second beam. In some aspects, a QCL beam indicated by the TCI state information may be considered a second predicted beam based at least in part on the QCL relationship with the first predicted beam.

The UE 120 may calculate one or more signal metrics based at least in part on the time duration shown by reference number 416, the TCI state information, and/or one or more beams (e.g., a predicted beam and/or an additional beam). In some aspects, the UE 120 may observe a difference in signal quality between a predicted beam (e.g., the first predicted beam or a second QCL predicted beam) and a second, non-predicted beam, where the difference may indicate that the second beam provides better performance (e.g., a higher signal quality) relative to the predicted beam. Alternatively or additionally, the difference may indicate that the predicted beam deviates from an expected performance by more than a tolerance threshold. Based at least in part on the UE 120 identifying the difference at a non-reporting time duration, the UE 120 may refrain from reporting an indication of the difference to the network node 402, and the network node 402 may communicate with the UE 120 based at least in part on a predicted beam that has reduced performance relative to other beams observed by the UE 120. The reduced performance may result in reduced data throughput, increased data-transfer latencies, and/or increased recovery errors.

Some techniques and apparatuses described herein provide network-controlled UE feedback of model inference error of network entity beam predictions. In some aspects, a network node (e.g., a base station 110 or an apparatus 1000) may transmit an indication of a trigger condition associated with a UE reporting a difference between a quality of a downlink reference signal and a quality of a Type-D QCL source reference signal associated with a physical downlink shared channel (PDSCH). The quality of the downlink reference signal and the Type-D QCL source reference signal may be based at least in part on a signal quality indicated by a signal metric. “Type-D QCL source reference signal” may denote a source reference signal that is defined as being QCL with another reference signal based at least in part on the signals having a same and/or commensurate (e.g., within a threshold or range) spatial relationship. As one example, the QCL signals may have a same and/or commensurate receiver spatial characteristic. A trigger condition may define one or more conditions that are used to qualify detecting the difference (e.g., the conditions must occur and/or must be present). In some aspects, the network node 402 may transmit the indication of the trigger condition to a UE and instruct the UE to report when the UE has detected the difference in quality and based at least in part on the trigger condition. Based at least in part on directing the UE to report detection of a difference in quality, the network node entity may receive an indication that the trigger condition has been detected.

In some aspects, a UE (e.g., a UE 120 or an apparatus 900) may obtain a first indication of a trigger condition associated with the UE reporting a difference between a quality of a downlink reference signal and a quality of a Type-D QCL source reference signal associated with PDSCH. As one example, the UE may receive the first indication of the trigger condition from a network node. As another example, the UE may obtain the first indication of the trigger condition by using a fixed trigger condition (e.g., stored in memory of the UE, stored in a file at the UE, and/or fixed in programming at the UE). Based at least in part on detecting the trigger condition and the difference, the UE may transmit a second indication that the trigger condition has been detected. As one example, the UE may transmit the second indication to a network node associated with communicating the trigger condition. The UE may detect the difference in quality based at least in part on a signal quality indicated by a signal metric.

A network node may preserve air interface resources by using machine learning techniques (e.g., a model trained based at least in part on a machine learning algorithm) to predict signal quality and/or a beam configuration. By configuring a UE with a trigger condition for detecting a difference between a predicted signal quality and a quality of a QCL signal, a network node may receive feedback to mitigate and/or correct model inference errors in a manner that uses fewer air interface resources relative to an increased frequency of signal metric reporting. In some aspects, a trigger condition may include multiple rules. Further, the UE may be configured dynamically by the network node or statically configured based at least in part on a fixed trigger condition. Specifying a trigger condition that must occur and/or be present for reporting a difference may qualify a difference report and improve the reporting by reducing the occurrence of false positives, reducing reports that indicate negligible differences, and improve mitigating model interference errors. Mitigating model inference errors may improve a predicted signal metric and/or predicted beam selection. Improving a predicted signal metric and/or predicted beam selection helps reduce recovery errors at a receiver, increase data throughput, and/or reduce data-transfer latencies (e.g., by reducing retransmissions).

As indicated above, FIG. 4 is provided as an example. Other examples may differ from what is described with regard to FIG. 4.

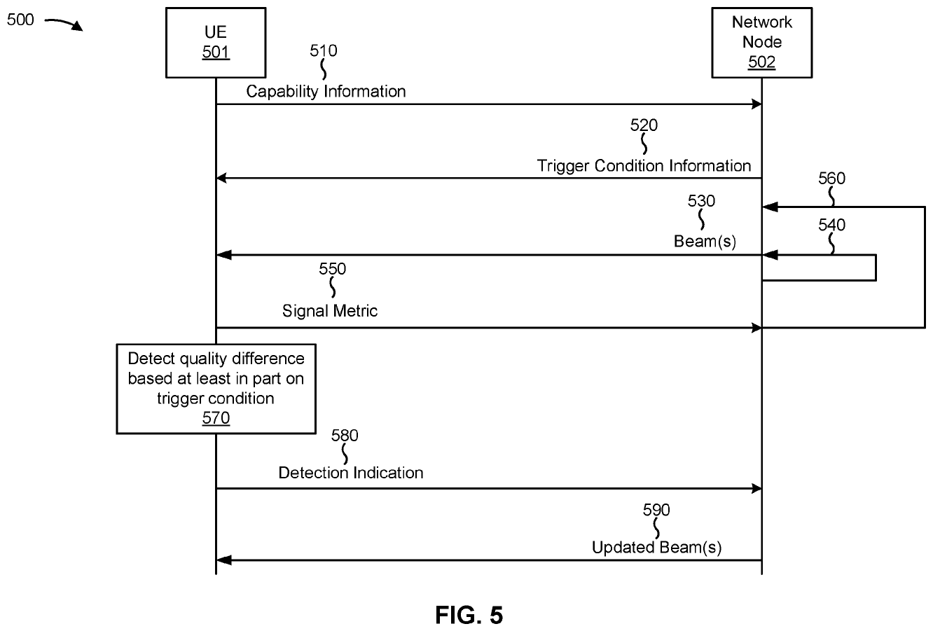

FIG. 5 is a diagram illustrating an example 500 of a wireless communication process that may be performed, at least in part, by a UE 501 (e.g., the UE 120 or an apparatus 900) and a network node 502 (e.g., a base station 110 or an apparatus 1000) in a wireless communication network, in accordance with the present disclosure.

As shown by reference number 510, the UE 501 may transmit, and the network node 502 may receive, capability information. In some aspects, the capability information may include one or more UE capabilities associated with reporting a difference in beam quality as further described with regard to FIGS. 3 and 4. As one example, the UE 501 may indicate a time window and/or length of the time window supported by the UE for measuring a set of downlink reference signals (e.g., a set of SSBs or a set of CSI-RSs). In some aspects, the time window may be associated with a data buffer capacity of the UE 501 (e.g., for storing digital samples of a downlink reference signal). Alternatively or additionally, the UE 501 may indicate a UE-supported trigger condition, such as a maximum number of downlink reference signals that the UE supports (e.g., a maximum number in a set of downlink reference signals), a first supported time window between a downlink reference signal and a start of a Type-D QCL source reference signal associated with the downlink reference signal, a second supported time window between the downlink reference signal and an indication of associated QCL information (e.g., via TCI state information), and/or a maximum quality difference (e.g., a range of a signal metric) observable by the UE. The UE 501 may alternatively or additionally indicate support for a standards-defined trigger condition (e.g., a trigger condition defined by a wireless communication standard).

In some aspects, the UE 501 may jointly indicate a time window and an associated maximum number of supported downlink reference signals based at least in part on a data buffer capacity of the UE. To illustrate, the UE 501 may indicate a first UE capability that indicates the UE 501 supports a 10 millisecond (msec) time window associated with four downlink reference signals, and a second UE capability that indicates the UE 501 also supports a 5 msec time window with eight downlink reference signals.

As shown by reference number 520, the network node 502 may transmit, and the UE 501 may receive, trigger condition information associated with reporting a difference in a quality of a downlink reference signal and a quality of a Type-D QCL source reference signal associated with a PDSCH. For example, the network node 502 may transmit trigger condition information using any combination of an RRC message, a MAC CE, and/or DCI. In some aspects, the network node 502 may transmit trigger condition information based at least in part on layer 1 signaling. While the example 500 shows the network node 502 transmitting, and the UE 501 receiving, the trigger condition information, other examples may include the UE 501 obtaining a trigger condition and/or other trigger condition information based at least in part on fixed trigger condition information (e.g., stored in memory of the UE, stored in a file at the UE, and/or fixed in programming at the UE) and/or pre-configured trigger condition information. Pre-configured trigger information may denote trigger condition information with a common definition between the network node 502 and the UE 501. In some aspects, pre-configured trigger information may be considered fixed trigger condition information.

A trigger condition may include one or more pre-conditions, rules, prerequisites, and/or arrangements for qualifying a detection of a quality difference as further described. As one example, a trigger condition may specify and/or indicate receiving a set of downlink reference signals (e.g., a set of CSI-RSs or a set of SSBs) as a pre-condition. In some aspects, the trigger condition may indicate a number of downlink reference signals for the set of downlink reference signals. To illustrate, a trigger condition may indicate to receive, as the set of downlink reference signals, 10 downlink reference signals (e.g., 10 CSI-RSs or 10 SSBs) prior to detecting the quality difference. Alternatively or additionally, the trigger condition may indicate to calculate a signal metric on each downlink reference signal in the set, such as an L1-RSRP metric and/or an L1-SINR metric.

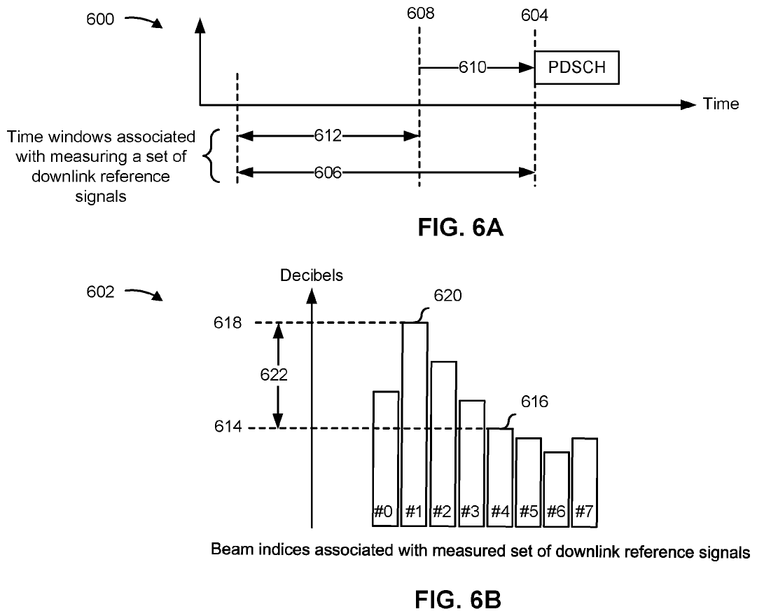

In some aspects, a trigger condition may indicate a time window for receiving a downlink reference signal (e.g., in the set of downlink reference signals) and/or for calculating a signal metric associated with the downlink reference signal, as further described with regard to FIG. 6B. As one example, the trigger condition may specify the time window based at least in part on indicating an end time for the time window. To illustrate, a first time (e.g., for the end time) may be associated with a start of the Type-D QCL source reference signal. A second time (e.g., for the end time) may be associated with the UE 501 obtaining QCL information. The trigger condition may specify the time window, a time duration for the time window, a start time associated with the time window, and/or an end time associated with the time window using a variety of units, such as a number of symbols, a number of slots, and/or a number of milliseconds. To illustrate, the trigger condition may indicate, as an end time for the time window, a first symbol associated with the start of the Type-D QCL source reference signal and/or a first symbol associated with the UE 501 receiving QCL information (e.g., via TCI state information). While the network node 502 may dynamically indicate the time window (e.g., via the trigger condition), other examples may include the UE 501 using a static and/or fixed time window.

The network node 502 may indicate, as a trigger condition, a value associated with a difference between the quality associated with the downlink reference signal and the quality associated with the Type-D QCL source reference signal. Alternatively or additionally, the network node 502 may indicate a difference threshold. To illustrate, the network node 502 may indicate, as the trigger condition, Y decibels (dBs) as the difference and/or the difference threshold, and instruct the UE 501 that the trigger condition has been satisfied when the UE 501 calculates that the difference between the downlink reference signal and the Type-D QCL source reference signal is at least Y dBs. Alternatively or additionally, the trigger condition may be satisfied based at least in part on the difference satisfying the difference threshold.

In some aspects, the trigger condition may indicate to trigger a report based at least in part on identifying that the quality difference satisfies the difference threshold for a single downlink reference signal and the Type-D QCL source reference. Alternatively, the trigger condition may indicate to trigger a report based at least in part on a quality difference for M downlink reference signals (e.g., in the set) and the Type-D QCL source reference signal satisfying the difference threshold, where Mis an integer. Thus, the trigger condition may be satisfied based at least in part on detecting a single quality difference (e.g., associated with a single downlink reference signal) or M quality differences (e.g., associated with M downlink reference signals).

In some aspects, the network node 502 may transmit CSI report configuration information that indicates a trigger condition. For example, the network node 502 may transmit an RRC message that indicates a CSI report configuration associated with a periodic CSI report, a semi-persistent CSI report, and/or an aperiodic CSI report.

In some aspects, the CSI report configuration information may indicate a trigger condition and instruct the UE 501 to activate trigger condition reporting based at least in part on the trigger condition. Trigger condition reporting may denote the UE 501 reporting the detection of a quality difference between a downlink reference signal and the Type-D QCL source reference signal based at least in part on the trigger condition being satisfied. Activating trigger condition reporting may denote triggering the start of monitoring for a quality difference and/or transmission of a detection indication. Deactivating trigger condition reporting may denote triggering the end of monitoring for a quality difference and/or transmission a detection indication. As one example of activating and/or configuring trigger condition reporting, the CSI report configuration may include a report quantity field (e.g., reportQuantity) and the network node 502 may set the report quantity field to a value (e.g., null) that indicates to activate trigger condition reporting. By setting the report quantity field to a null value, the network node 502 may instruct the UE 501 to calculate (and refrain from transmitting) one or more signal metrics associated with signal quality. The CSI report configuration may alternatively or additionally instruct the UE 501 to transmit an indication of detecting a signal quality difference. Calculating a signal metric, but refraining from transmitting the signal metric until a signal quality difference is detected, may help preserve air interface resources for other purposes and/or devices.

In some aspects, the CSI report configuration may indicate one or more channel measurement resource settings (e.g., for periodic or semi-persistent CSI reporting) that may be associated with measuring the downlink reference signal and/or the set of downlink reference signals. Alternatively or additionally, for aperiodic CSI reporting, the CSI report configuration may indicate a trigger condition based at least in part on aperiodic CSI trigger state information.

The network node 502 may transmit the trigger condition information based at least in part on multiple communications with the UE 501. To illustrate, in a first communication (e.g., an RRC message), the network node 502 may indicate multiple trigger conditions associated with reporting the quality difference. For example, the network node 502 may indicate the multiple trigger conditions in the CSI reporting configuration information. In a second communication, the network node 502 may activate trigger condition reporting, such as by transmitting a MAC CE to the UE 501 that indicates to activate trigger condition reporting based at least in part on one of the multiple trigger conditions. The MAC CE may indicate a selection of one of the multiple trigger conditions and instruct the UE 501 to activate trigger condition reporting based at least in part on the selected trigger condition. Alternatively or additionally, the network node 502 may activate trigger condition reporting and/or indicate selection of one of the multiple trigger conditions based at least in part on configuring one or more fields in DCI.

As shown by reference number 530, the network node 502 may transmit, and the UE 501 may receive, one or more beams. In some aspects, the network node 502 may transmit a reference signal on a beam, such as a CSI-RS and/or a SSB. As shown by reference number 540, the network node 502 may iteratively transmit the one or more beams. In some aspects, the network node 502 may predict a signal metric, a beam, and/or a beam pair based at least in part on a model trained on machine learning (e.g., the module(s) 404) and update which beam is used to transmit the reference signal. For example, and as similarly described with regard to FIG. 4, the network node 502 may update the beam every 20 msec based at least in part on the module(s) 404. In some aspects, the network node 502 may indicate QCL information associated with the downlink reference signal to the UE 501, such as by transmitting TCI state information that indicates the QCL information associated with a Type-D QCL source reference signal based at least in part on PDSCH.

As shown by reference number 550, the UE 501 may transmit, and the network node 502 may receive, a signal metric associated with the beam(s) described with regard to reference number 530. As shown by reference number 560, the UE 120 may iteratively transmit a signal metric as described with regard to FIG. 4. To illustrate, the UE 501 may transmit a signal metric every 120 msec. In some aspects, the UE 501 may transmit the signal metric at a lower frequency (e.g., every 120 msec) relative to calculating the signal metric (e.g., every 20 msec). Alternatively or additionally, the UE 501 may transmit the signal metric at a lower frequency relative to the network node 502 predicting a signal metric and/or beam (e.g., every 20 msec).

As shown by reference number 570, the UE 501 may detect a difference in a quality of a downlink reference signal and a quality of a Type-D QCL source reference signal associated with a PDSCH. The UE 501 may detect the quality difference based at least in part on a trigger condition indicated by the network node 502 and/or a fixed trigger condition. To detect the quality difference, the UE 501 may calculate an L1-RSRP metric and/or an L1-SINR metric for each of the downlink reference signal and the Type-D QCL source reference signal. In some aspects, the UE 501 may identify the Type-D QCL source reference signal based at least in part on a TCI state activated by the network node 502 (e.g., via DCI), where the activated TCI state may be associated with the downlink reference signal. Alternatively or additionally, the set of downlink reference signals may be associated with one or more activated TCI states. In some aspects, a UE may identify the Type-D QCL source reference signal based at least in part on the set of downlink reference signals indicated by a network node.

The UE 501 may generate a respective signal metric for each downlink reference signal in a set of downlink reference signals (e.g., indicated by the CSI report configuration information). As further described above, the UE 501 may detect the difference in quality based at least in part on a signal quality indicated by a signal metric. Based at least in part on the trigger condition, the UE 501 may determine that the difference in quality has been detected based at least in part on detecting M differences in M reference signals, where Mis an integer.

The UE 501 may calculate one or more signal metrics associated with the set of downlink reference signals based at least in part on a time window (e.g., indicated by the trigger condition). As further described with regard to FIG. 6A, the time window may be based at least in part on a start of the Type-D QCL source reference signal and/or a start of receiving the QCL information. Thus, the UE 501 may detect the difference in quality based at least in part on receiving the downlink reference signal (and/or the set of downlink reference signals) within the time window. Alternatively or additionally, the UE 501 may detect the difference in quality based at least in part on the calculated difference satisfying a difference threshold.

As shown by reference number 580, the UE 501 may transmit, and the network node 502 may receive, a detection indication associated with the UE 501 detecting the difference in quality and based at least in part on the trigger condition. Thus, the UE 501 may conditionally transmit the detection indication based at least in part on a trigger condition, such as a trigger condition associated with detecting the difference prior to a point in time associated with a start of the Type-D QCL source reference signal. For example, based at least in part on detecting the difference after the point in time associated with the start of the Type-D QCL source reference signal, the UE 501 may refrain from transmitting the detection indication based at least in part on the trigger condition not being satisfied.

In some aspects, the UE 501 may transmit a bit that has an explicit association with reporting that the trigger condition and/or the difference in quality has been detected. Alternatively or additionally, the UE 501 may set the bit to a value explicitly defined to indicate that the trigger condition and/or the difference in quality has been detected. To illustrate, the UE 501 may transmit the detection indication using a field (e.g., a field with one or more bits) of a MAC CE, such as a reserved bit of a beam failure recovery MAC CE or a trigger condition MAC CE associated with, and/or defined for, reporting that the difference has been detected. Alternatively or additionally, the UE 501 may transmit the detection indication using any combination of an RRC message, a MAC CE, and/or uplink control information (UCI).

In some aspects, the UE 501 may indicate, with the detection indication, a UE-selected Type-D QCL source reference signal as further described with regard to FIG. 6B. Alternatively or additionally, the UE 501 may transmit, with the detection indication, the difference calculated by the UE 501 and/or an indication of the difference calculated by the UE 501.

In some aspects, the UE 501 may implicitly transmit the detection indication. To illustrate, the UE 501 may transmit, and the network node 502 may receive, a request to increase a frequency of calculating a signal metric and/or reporting the signal metric. As one example, the UE 501 may be configured (e.g., by the network node 502) to calculate (and refrain from transmitting) one or more signal metrics associated with a CSI report at a first periodicity and/or a first frequency. The UE 501 may alternatively or additionally be configured to report a signal metric at the first periodicity and/or the first frequency. To transmit the detection indication implicitly, the UE 501 may transmit a request to increase a frequency of calculating and/or reporting the signal metric, such as by transmitting an indication of a second periodicity that is shorter than the first periodicity and/or by transmitting an indication of a second frequency that is higher than the first frequency.

As another example of implicitly transmitting the detection indication, the UE 501 may transmit a scheduling request for a physical uplink control channel resource (PUCCH). To illustrate, the UE 501 may determine, based at least in part on a lack of uplink resources, to transmit the scheduling request for an uplink resource associated with transmitting the detection indication. Based at least in part on transmitting the scheduling request, the UE 501 may receive an indication of an uplink resource assignment and transmit the detection indication based at least in part on the uplink resource assignment.

As shown by reference number 590, the network node 502 may transmit, and the UE 501 may receive, an updated beam that is based at least in part on the network node 502 updating a model trained on a machine learning algorithm (e.g., the module(s) 404) and/or the detection indication from the UE 501. As one example, the network node 502 may receive the calculated difference from the UE 501 and update the model based at least in part on the calculated difference. As another example, the network node 502 may reselect beams based at least in part on a UE-selected Type-D QCL source reference signal.

By configuring a UE with a trigger condition for detecting a difference between a predicted signal quality and a quality of a QCL signal, a network node may receive feedback to mitigate and/or correct model inference errors in a manner that uses fewer air interface resources relative to an increased frequency of signal metric reporting. Specifying a trigger condition that must occur and/or be present for reporting a difference may qualify a difference report and improve the reporting by reducing the occurrence of false positives, reducing reports that indicate negligible differences, and improve mitigating model interference errors. Mitigating model inference errors may improve predicted beam selection and/or predicted signal metrics and result in beam selections that reduce recovery errors at a receiver, increase data throughput, and/or reduce data-transfer latencies (e.g., by reducing retransmissions) relative to the other beams.

As indicated above, FIG. 5 is provided as an example. Other examples may differ from what is described with regard to FIG. 5.

FIGS. 6A and 6B are diagrams illustrating a first example 600 and a second example 602 of detecting a difference in quality based at least in part on a trigger condition, in accordance with the present disclosure.

As shown by the example 600, a first time 604 may be associated with a start time of a Type-D QCL source reference signal transmission associated with PDSCH. In some aspects, a trigger condition may indicate a time window 606 for measuring one or more downlink reference signals (e.g., a set of downlink reference signals) based at least in part on the first time 604. As one example, the trigger condition may indicate, as the end time of the first time window 606, a starting symbol of the Type-D QCL source reference signal transmission. Alternatively or additionally, the trigger condition may indicate a start time and/or a time duration of the first time window 606. The trigger condition may indicate the start time, end time, and/or time duration based at least in part on any combination of a number of symbols, a number of slots, and/or a number of milliseconds. As further described above, a UE may identify the Type-D QCL source reference signal transmission based at least in part on TCI state information indicated by a network node. Alternatively or additionally, the UE may identify the Type-D QCL source reference signal transmission based at least in part on the set of downlink reference signals indicated by a network node.

A second time 608 may be associated with a UE (e.g., a UE 120 or an apparatus 900) receiving an indication of QCL information from a network node (e.g., a base station 110 or an apparatus 1000). In some aspects, the UE may receive the QCL information based at least in part on receiving DCI that indicates selection of one or more TCI states. Alternatively or additionally, the second time 608 may be associated with a start of a PDSCH preparation procedure associated with the Type-D QCL source reference signal associated with PDSCH. The PDSCH preparation procedure may be configured to operate for a time duration 610 (e.g., until the first time 604). In some aspects, the UE may receive an indication of a start time associated with the PDSCH preparation procedure (e.g., the second time 608) and/or a time duration of the PDSCH preparation procedure based at least in part on PDSCH scheduling information. In some aspects, a trigger condition may indicate a time window 612 for measuring one or more downlink reference signals (e.g., a set of downlink reference signals), such as by indicating the second time 608 and/or a time duration associated with the time window based at least in part on a number of symbols, a number of slots, and/or a number of milliseconds.

As shown by the example 602, a UE (e.g., a UE 120 or an apparatus 900) may calculate one or more signal metrics associated with one or more downlink reference signals. As one example, the UE may calculate a first signal metric 614 for a first reference signal associated with a first beam 616, shown by the example 602 as having a unit of dBs. In some aspects, the first signal metric 614 and/or the first beam 616 may be associated with a predicted beam as further described with regard to FIG. 3 and FIG. 4. In some aspects, the first beam 616 may be associated with a Type-D QCL source reference signal associated with PDSCH. Based at least in part on an instruction to calculate one or more signal metrics for a set of downlink reference signals, the UE may calculate a second signal metric 618 for a second reference signal associated with a second beam 620. The UE may identify that a difference 622 between the first signal metric 614 and the second signal metric 618 may satisfy a difference threshold associated with a trigger condition. Alternatively or additionally, and based at least in part on the calculating and/or identifying, a UE may transmit an indication of a UE-selected Type-D QCL source reference signal (e.g., the second beam 620) that may have a better signal quality relative to the predicted beam.

By measuring a downlink reference signal based at least in part on a trigger condition, a UE may qualify a detected difference between a predicted signal quality and a quality of a QCL signal, and the UE may transmit the qualified feedback to a network node and help mitigate model inference errors. Mitigating model inference errors may improve predicted beam selection and/or predicted signal metrics and result in beam selections that reduce recovery errors at a receiver, increase data throughput, and/or reduce data-transfer latencies (e.g., by reducing retransmissions) relative to the other beams.

As indicated above, FIGS. 6A and 6B are provided as an example. Other examples may differ from what is described with regard to FIGS. 6A and 6B.

FIG. 7 is a diagram illustrating an example process 700 performed, for example, by a UE, in accordance with the present disclosure. Example process 700 is an example where the UE (e.g., a UE 120 or apparatus 900) performs operations associated with network controlled UE feedback of model inference error of network entity beam predictions.

As shown in FIG. 7, in some aspects, process 700 may include obtaining a trigger condition associated with reporting a difference between a quality of a downlink reference signal and a quality of a Type-D QCL source reference signal associated with a PDSCH (block 710). For example, the UE (e.g., using communication manager 140 and/or quality difference detection component 908, depicted in FIG. 9) may obtain a trigger condition associated with reporting a difference between a quality of a downlink reference signal and a quality of a Type-D QCL source reference signal associated with a PDSCH, as described above.

As further shown in FIG. 7, in some aspects, process 700 may include transmitting, to a network node, a detection indication associated with detecting the trigger condition (block 720). For example, the UE (e.g., using communication manager 140 and/or transmission component 904, depicted in FIG. 9) may transmit, to a network node, a detection indication associated with detecting the trigger condition, as described above.

Process 700 may include additional aspects, such as any single aspect or any combination of aspects described below and/or in connection with one or more other processes described elsewhere herein.

In a first aspect, obtaining the trigger condition associated with reporting the difference comprises receiving the trigger condition based at least in part on at least one of an RRC message, a MAC CE, or downlink control information.

In a second aspect, alone or in combination with the first aspect, obtaining the trigger condition is based at least in part on a pre-configured trigger condition or a fixed trigger condition.

In a third aspect, alone or in combination with one or more of the first and second aspects, the downlink reference signal is included in a set of downlink reference signals, and the trigger condition includes a pre-condition associated with receiving the set of downlink reference signals.

In a fourth aspect, alone or in combination with one or more of the first through third aspects, the set of downlink reference signals comprises at least one of a first set of channel state information reference signals, or a second set of synchronization signal blocks.

In a fifth aspect, alone or in combination with one or more of the first through fourth aspects, process 700 includes identifying the Type-D QCL source reference signal associated with the PDSCH based at least in part on the set of downlink reference signals.

In a sixth aspect, alone or in combination with one or more of the first through fifth aspects, identifying the Type-D QCL source reference signal is based at least in part on an activated TCI state.

In a seventh aspect, alone or in combination with one or more of the first through sixth aspects, the trigger condition comprises generating at least one signal metric based at least in part on the set of reference signals, the generating occurring within a time window that occurs before a first time associated with a start of the Type-D QCL source reference signal, or a second time associated with obtaining QCL information.

In an eighth aspect, alone or in combination with one or more of the first through seventh aspects, the quality of the downlink reference signal is based at least in part on the at least one signal metric.

In a ninth aspect, alone or in combination with one or more of the first through eighth aspects, the at least one signal metric comprises an RSRP metric, or an SINR signal metric.

In a tenth aspect, alone or in combination with one or more of the first through ninth aspects, the time window is based at least in part on at least one of a first number of symbols, a second number of slots, or a third number of milliseconds.

In an eleventh aspect, alone or in combination with one or more of the first through tenth aspects, the start of the Type-D QCL source reference signal is based at least in part on at least one of a first number of symbols, a second number of slots, or a third number of milliseconds.

In a twelfth aspect, alone or in combination with one or more of the first through eleventh aspects, process 700 includes receiving configuration information that indicates the time window, or using a fixed time window as the time window.

In a thirteenth aspect, alone or in combination with one or more of the first through twelfth aspects, the trigger condition comprises the difference between the quality associated with the downlink reference signal and the quality associated with the Type-D QCL source reference signal satisfying a difference threshold.

In a fourteenth aspect, alone or in combination with one or more of the first through thirteenth aspects, the trigger condition comprises detecting that the difference satisfies the difference threshold a number of times.

In a fifteenth aspect, alone or in combination with one or more of the first through fourteenth aspects, process 700 includes receiving CSI report configuration information associated with a periodic or semi-persistent CSI report, wherein the CSI report configuration information indicates the trigger condition.

In a sixteenth aspect, alone or in combination with one or more of the first through fifteenth aspects, process 700 includes receiving the CSI report configuration information using a radio resource control message.

In a seventeenth aspect, alone or in combination with one or more of the first through sixteenth aspects, the CSI report configuration information indicates to activate trigger condition reporting.

In an eighteenth aspect, alone or in combination with one or more of the first through seventeenth aspects, the CSI report configuration information comprises a report quantity field that is set to a value that indicates to activate the trigger condition reporting.

In a nineteenth aspect, alone or in combination with one or more of the first through eighteenth aspects, the CSI report configuration information comprises a channel measurement resource setting associated with the downlink reference signal.

In a twentieth aspect, alone or in combination with one or more of the first through nineteenth aspects, the CSI report configuration information indicates multiple trigger conditions associated with reporting the difference, and process 700 includes receiving a MAC CE that indicates to activate trigger condition reporting based at least in part on one of the multiple trigger conditions, wherein the MAC CE specifies the one of the multiple trigger conditions.

In a twenty-first aspect, alone or in combination with one or more of the first through twentieth aspects, the CSI report configuration information indicates multiple trigger conditions associated with reporting the difference, wherein the multiple trigger conditions include the trigger condition, and process 700 includes receiving downlink control information that indicates the trigger condition, and activation of trigger condition reporting based at least in part on the trigger condition.

In a twenty-second aspect, alone or in combination with one or more of the first through twenty-first aspects, process 700 includes receiving CSI report configuration information that indicates to activate an aperiodic CSI report, wherein the CSI report configuration information further indicates to activate trigger condition reporting by setting a report quantity field to a value that indicates to activate the trigger condition reporting.

In a twenty-third aspect, alone or in combination with one or more of the first through twenty-second aspects, the CSI report configuration information indicates the trigger condition based at least in part on an aperiodic CSI trigger state associated with the aperiodic CSI report.

In a twenty-fourth aspect, alone or in combination with one or more of the first through twenty-third aspects, transmitting the detection indication further comprises transmitting, as the detection indication, a bit that is set to a value explicitly defined to indicate that the trigger condition has been detected.

In a twenty-fifth aspect, alone or in combination with one or more of the first through twenty-fourth aspects, process 700 includes transmitting, with the detection indication, a UE-selected Type-D QCL source reference signal.

In a twenty-sixth aspect, alone or in combination with one or more of the first through twenty-fifth aspects, process 700 includes transmitting, with the detection indication, an indication of the difference.

In a twenty-seventh aspect, alone or in combination with one or more of the first through twenty-sixth aspects, transmitting the detection indication further comprises transmitting the detection indication implicitly by transmitting a request to increase a frequency of calculating a signal metric associated with a beam.

In a twenty-eighth aspect, alone or in combination with one or more of the first through twenty-seventh aspects, the trigger condition is based at least in part on a periodic or semi-persistent CSI report associated with a first periodicity, and transmitting the request to increase the frequency further comprises transmitting an indication of a second periodicity that is shorter than the first periodicity.

In a twenty-ninth aspect, alone or in combination with one or more of the first through twenty-eighth aspects, transmitting the detection indication further comprises conditionally transmitting the detection indication based at least in part on detecting the difference prior to a start time associated with transmission of the Type-D QCL source reference signal.

In a thirtieth aspect, alone or in combination with one or more of the first through twenty-ninth aspects, transmitting the detection indication further comprises transmitting the detection indication based at least in part on a MAC CE.

In a thirty-first aspect, alone or in combination with one or more of the first through thirtieth aspects, transmitting the detection indication based at least in part on the MAC CE further comprises using a reserved bit of a beam failure recovery MAC CE, or using a trigger condition MAC CE associated with reporting that the difference has been detected.

In a thirty-second aspect, alone or in combination with one or more of the first through thirty-first aspects, process 700 includes determining, based at least in part on a lack of uplink resources, to transmit a scheduling request for an uplink resource associated with transmitting the detection indication, transmitting the scheduling request for a physical uplink control channel resource, and receiving an indication of an uplink resource assignment, wherein transmitting the detection indication further comprises transmitting the detection indication based at least in part on the uplink resource assignment.

In a thirty-third aspect, alone or in combination with one or more of the first through thirty-second aspects, process 700 includes transmitting capability information that indicates support for the trigger condition, and receiving an indication of the trigger condition based at least in part on transmitting the capability information.

In a thirty-fourth aspect, alone or in combination with one or more of the first through thirty-third aspects, the capability information indicates support for a standards-defined trigger condition.

In a thirty-fifth aspect, alone or in combination with one or more of the first through thirty-fourth aspects, the capability information indicates a supported time window associated with monitoring a set of downlink reference signals, and the trigger condition is based at least in part on the supported time window.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a network node, in accordance with the present disclosure. Example process 800 is an example where the network node (e.g., a base station 110 or an apparatus 1000) performs operations associated network controlled UE feedback of model inference error of network entity beam predictions.

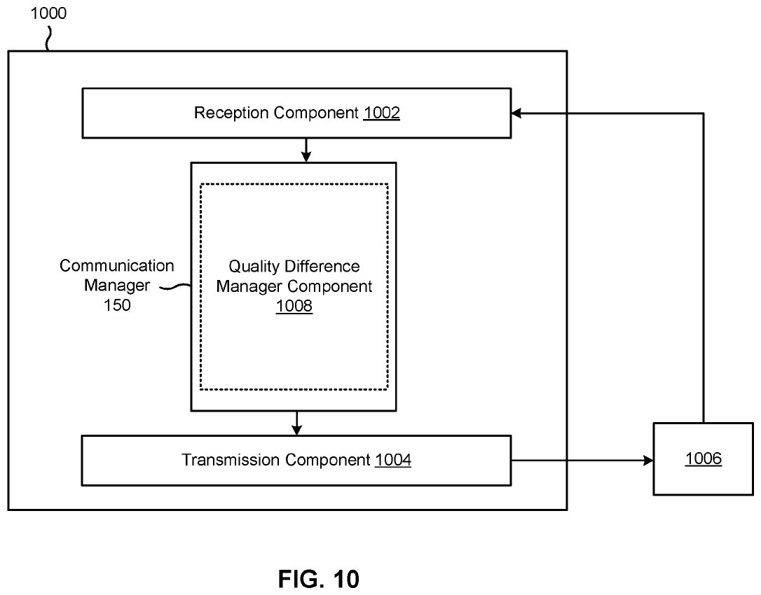

As shown in FIG. 8, in some aspects, process 800 may include transmitting a trigger condition associated with reporting a difference between a quality of a downlink reference signal and a quality of a Type-D QCL source reference signal associated with a PDSCH (block 810). For example, the network node (e.g., using communication manager 150 and/or transmission component 1004, depicted in FIG. 10) may transmit a trigger condition associated with reporting a difference between a quality of a downlink reference signal and a quality of a Type-D QCL source reference signal associated with a PDSCH, as described above.

As further shown in FIG. 8, in some aspects, process 800 may include receiving a detection indication associated with detecting the trigger condition (block 820). For example, the network node (e.g., using communication manager 150 and/or reception component 1002, depicted in FIG. 10) may receive a detection indication associated with detecting the trigger condition, as described above.

Process 800 may include additional aspects, such as any single aspect or any combination of aspects described below and/or in connection with one or more other processes described elsewhere herein.

In a first aspect, transmitting the trigger condition associated with reporting the difference comprises transmitting the trigger condition based at least in part on at least one of an RRC message, a MAC CE, or downlink control information.

In a second aspect, alone or in combination with the first aspect, the downlink reference signal is included in a set of downlink reference signals, and the trigger condition includes a pre-condition associated with receiving the set of downlink reference signals.

In a third aspect, alone or in combination with one or more of the first and second aspects, the set of downlink reference signals comprises at least one of a first set of channel state information reference signals, or a second set of synchronization signal blocks.

In a fourth aspect, alone or in combination with one or more of the first through third aspects, the trigger condition comprises generating at least one signal metric based at least in part on the set of reference signals, the generating occurring within a time window that occurs before a first time associated with a start of the Type-D QCL source reference signal, or a second time associated with obtaining QCL information.

In a fifth aspect, alone or in combination with one or more of the first through fourth aspects, the quality of the downlink reference signal is based at least in part on the at least one signal metric.

In a sixth aspect, alone or in combination with one or more of the first through fifth aspects, the at least one signal metric comprises a reference signal received power signal metric, or a signal-to-interference-plus-noise-ratio signal metric.

In a seventh aspect, alone or in combination with one or more of the first through sixth aspects, the time window is based at least in part on at least one of a first number of symbols, a second number of slots, or a third number of milliseconds.

In an eighth aspect, alone or in combination with one or more of the first through seventh aspects, the start of the Type-D QCL source reference signal is based at least in part on at least one of a first number of symbols, a second number of slots, or a third number of milliseconds.

In a ninth aspect, alone or in combination with one or more of the first through eighth aspects, the trigger condition comprises the difference between the quality associated with the downlink reference signal and the quality associated with the Type-D QCL source reference signal satisfying a difference threshold.

In a tenth aspect, alone or in combination with one or more of the first through ninth aspects, the trigger condition comprises detecting that the difference satisfies the difference threshold a number of times.

In an eleventh aspect, alone or in combination with one or more of the first through tenth aspects, process 800 includes transmitting CSI report configuration information associated with a periodic or semi-persistent CSI report, wherein the CSI report configuration information indicates the trigger condition.

In a twelfth aspect, alone or in combination with one or more of the first through eleventh aspects, process 800 includes transmitting the CSI report configuration information using a radio resource control message.

In a thirteenth aspect, alone or in combination with one or more of the first through twelfth aspects, the CSI report configuration information indicates to activate trigger condition reporting.

In a fourteenth aspect, alone or in combination with one or more of the first through thirteenth aspects, the CSI report configuration information comprises a report quantity field that is set to a value that indicates to activate the trigger condition reporting.

In a fifteenth aspect, alone or in combination with one or more of the first through fourteenth aspects, the CSI report configuration information comprises a channel measurement resource setting associated with the downlink reference signal.

In a sixteenth aspect, alone or in combination with one or more of the first through fifteenth aspects, the CSI report configuration information indicates multiple trigger conditions associated with reporting the difference, and process 800 includes transmitting a MAC CE that indicates to activate trigger condition reporting based at least in part on one of the multiple trigger conditions, wherein the MAC CE specifies the one of the multiple trigger conditions.

In a seventeenth aspect, alone or in combination with one or more of the first through sixteenth aspects, the CSI report configuration information indicates multiple trigger conditions associated with reporting the difference, wherein the multiple trigger conditions include the trigger condition, and process 800 includes transmitting downlink control information that indicates the trigger condition, and activation of trigger condition reporting based at least in part on the trigger condition.

In an eighteenth aspect, alone or in combination with one or more of the first through seventeenth aspects, process 800 includes transmitting CSI report configuration information that indicates to activate an aperiodic CSI report, wherein the CSI report configuration information further indicates to activate trigger condition reporting by setting a report quantity field to a value that indicates to activate the trigger condition reporting.

In a nineteenth aspect, alone or in combination with one or more of the first through eighteenth aspects, the CSI report configuration information indicates the trigger condition based at least in part on an aperiodic CSI trigger state associated with the aperiodic CSI report.

In a twentieth aspect, alone or in combination with one or more of the first through nineteenth aspects, receiving the detection indication further comprises receiving, as the detection indication, a bit that is set to a value explicitly defined to indicate that the trigger condition has been detected.

In a twenty-first aspect, alone or in combination with one or more of the first through twentieth aspects, process 800 includes receiving, with the detection indication, a UE-selected Type-D QCL source reference signal.

In a twenty-second aspect, alone or in combination with one or more of the first through twenty-first aspects, process 800 includes receiving, with the detection indication, an indication of the difference.

In a twenty-third aspect, alone or in combination with one or more of the first through twenty-second aspects, receiving the detection indication further comprises receiving the detection indication implicitly by receiving a request to increase a frequency of calculating a signal metric associated with a beam.

In a twenty-fourth aspect, alone or in combination with one or more of the first through twenty-third aspects, the trigger condition is based at least in part on a periodic or semi-persistent CSI report associated with a first periodicity, and receiving the request to increase the frequency further comprises receiving an indication of a second periodicity that is shorter than the first periodicity.

In a twenty-fifth aspect, alone or in combination with one or more of the first through twenty-fourth aspects, receiving the detection indication further comprises receiving the detection indication based at least in part on a MAC CE.

In a twenty-sixth aspect, alone or in combination with one or more of the first through twenty-fifth aspects, receiving the detection indication based at least in part on the MAC CE further comprises receiving the detection indication in a reserved bit of a beam failure recovery MAC CE, or receiving a trigger condition MAC CE associated with reporting that the difference has been detected.

In a twenty-seventh aspect, alone or in combination with one or more of the first through twenty-sixth aspects, process 800 includes receiving a scheduling request for an uplink resource associated with transmitting the detection indication, and transmitting an indication of an uplink resource assignment, wherein receiving the detection indication further comprises receiving the detection indication based at least in part on the uplink resource assignment.

In a twenty-eighth aspect, alone or in combination with one or more of the first through twenty-seventh aspects, process 800 includes receiving capability information that indicates support for the trigger condition, and transmitting an indication of the trigger condition based at least in part on receiving the capability information.

In a twenty-ninth aspect, alone or in combination with one or more of the first through twenty-eighth aspects, the capability information indicates support for a standards-defined trigger condition.

In a thirtieth aspect, alone or in combination with one or more of the first through twenty-ninth aspects, the capability information indicates a supported time window associated with monitoring a set of downlink reference signals, and the trigger condition is based at least in part on the supported time window.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a network node, or another wireless communication device) using the reception component 902 and the transmission component 904. As further shown, the apparatus 900 may include the communication manager 140. The communication manager 140 may include one or more of a quality difference detection component 908, among other examples.

In some aspects, the apparatus 900 may be configured to perform one or more operations described herein in connection with FIGS. 3-6. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The quality difference detection component 908 may obtain a trigger condition associated with reporting a difference between a quality of a downlink reference signal and a quality of a Type-D quasi co-located (QCL) source reference signal associated with a physical downlink shared control channel (PDSCH). The transmission component 904 may transmit, to a network node, a detection indication associated with detecting the trigger condition.

The quality difference detection component 908 may identify the Type-D QCL source reference signal associated with the PDSCH based at least in part on the set of downlink reference signals.

The reception component 902 may receive configuration information that indicates the time window. In some aspects, the quality difference detection component 908 may use a fixed time window as the time window.

The reception component 902 may receive CSI report configuration information associated with a periodic or semi-persistent CSI report, wherein the CSI report configuration information indicates the trigger condition. In some aspects, the reception component 902 may receive the CSI report configuration information using a radio resource control message. As one example, the reception component 902 may receive CSI report configuration information that indicates to activate an aperiodic CSI report, wherein the CSI report configuration information further indicates to activate trigger condition reporting by setting a report quantity field to a value that indicates to activate the trigger condition reporting.

The transmission component 904 may transmit, with the detection indication, a UE-selected Type-D QCL source reference signal. In some aspects, the transmission component 904 may transmit, with the detection indication and/or the UE-selected Type-D QCL source reference signal, an indication of the difference.

The quality difference detection component 908 may determine, based at least in part on a lack of uplink resources, to transmit a scheduling request for an uplink resource associated with transmitting the detection indication. In some aspects, the transmission component 904 may transmit the scheduling request for a physical uplink control channel resource.

The reception component 902 may receive an indication of an uplink resource assignment, wherein transmitting the detection indication further comprises transmitting the detection indication based at least in part on the uplink resource assignment.

The transmission component 904 may transmit capability information that indicates support for the trigger condition. Alternatively or additionally, the reception component 902 may receive an indication of the trigger condition based at least in part on transmitting the capability information.

The number and arrangement of components shown in FIG. 9 are provided as an example. In practice, there may be additional components, fewer components, different components, or differently arranged components than those shown in FIG. 9.

Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication. The apparatus 1000 may be a network node, or a network node may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 150. The communication manager 150) may include one or more of a quality difference manager component 1008, among other examples.

In some aspects, the apparatus 1000 may be configured to perform one or more operations described herein in connection with FIGS. 3-6. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the network node described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the network node described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the network node described in connection with FIG. 2. In some aspects, the transmission component 1004 may be co-located with the reception component 1002 in a transceiver.

The quality difference manager component 1008 may select one or more trigger conditions for a UE. In some aspects, the quality difference manager component 1008 may select a trigger condition based at least in part on UE capability information.

The transmission component 1004 may transmit a trigger condition associated with reporting a difference between a quality of a downlink reference signal and a quality of a Type-D quasi co-located QCL source reference signal associated with a PDSCH. The reception component 1002 may receive a detection indication associated with detecting the trigger condition.

The transmission component 1004 may transmit CSI report configuration information associated with a periodic or semi-persistent CSI report, wherein the CSI report configuration information indicates the trigger condition. As one example, the transmission component 1004 may transmit the CSI report configuration information using a radio resource control message. In some aspects, the transmission component 1004 may transmit CSI report configuration information that indicates to activate an aperiodic CSI report, wherein the CSI report configuration information further indicates to activate trigger condition reporting by setting a report quantity field to a value that indicates to activate the trigger condition reporting.

The reception component 1002 may receive, with the detection indication, a UE-selected Type-D QCL source reference signal. Alternatively or additionally, the reception component 1002 may receive, with the detection indication, an indication of the difference.

The quality difference manager component 1008 may modify an input to a beam and/or signal prediction module (e.g., the module(s) 404) based at least in part on the detection indication.

The reception component 1002 may receive a scheduling request for an uplink resource associated with transmitting the detection indication. Based at least in part on the reception component 1002 receiving the scheduling request, the transmission component 1004 may transmit an indication of an uplink resource assignment, wherein receiving the detection indication further comprises receiving the detection indication based at least in part on the uplink resource assignment.

The reception component 1002 may receive capability information that indicates support for the trigger condition. Based at least in part on the reception component 1002 receiving the capability information, the transmission component 1004 may transmit an indication of the trigger condition.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: obtaining a trigger condition associated with reporting a difference between a quality of a downlink reference signal and a quality of a Type-D quasi co-located (QCL) source reference signal associated with a physical downlink shared control channel (PDSCH); and transmitting, to a network node, a detection indication associated with detecting the trigger condition.

Aspect 2: The method of Aspect 1, wherein obtaining the trigger condition associated with reporting the difference comprises: receiving the trigger condition based at least in part on at least one of: a radio resource control (RRC) message, a medium access control (MAC) control element (CE), or downlink control information.

Aspect 3: The method of Aspect 1, wherein obtaining the trigger condition is based at least in part on a pre-configured trigger condition or a fixed trigger condition.

Aspect 4: The method of any one of Aspects 1-3, wherein the downlink reference signal is included in a set of downlink reference signals, and wherein the trigger condition includes a pre-condition associated with receiving the set of downlink reference signals.

Aspect 5: The method of Aspect 4, wherein the set of downlink reference signals comprises at least one of: a first set of channel state information reference signals; or a second set of synchronization signal blocks.

Aspect 6: The method of Aspect 4, further comprising: identifying the Type-D QCL source reference signal associated with the PDSCH based at least in part on the set of downlink reference signals.

Aspect 7: The method of Aspect 6, wherein identifying the Type-D QCL source reference signal is based at least in part on an activated transmission configuration indicator (TCI) state.

Aspect 8: The method of Aspect 4, wherein the trigger condition comprises: generating at least one signal metric based at least in part on the set of reference signals, the generating occurring within a time window that occurs before: a first time associated with a start of the Type-D QCL source reference signal; or a second time associated with obtaining QCL information.

Aspect 9: The method of any one of Aspects 1-8, wherein the quality of the downlink reference signal is based at least in part on the at least one signal metric.

Aspect 10: The method of Aspect 9, wherein the at least one signal metric comprises: a reference signal received power signal metric, or a signal-to-interference-plus-noise-ratio signal metric.

Aspect 11: The method of any one of Aspects 8-10, wherein the time window is based at least in part on at least one of: a first number of symbols, a second number of slots, or a third number of milliseconds.

Aspect 12: The method of any one of Aspects 8-11, wherein the start of the Type-D QCL source reference signal is based at least in part on at least one of: a first number of symbols, a second number of slots, or a third number of milliseconds.

Aspect 13: The method of any one of Aspects 8-12, further comprising: receiving configuration information that indicates the time window; or using a fixed time window as the time window.

Aspect 14: The method of any one of Aspects 1-13, wherein the trigger condition comprises the difference between the quality associated with the downlink reference signal and the quality associated with the Type-D QCL source reference signal satisfying a difference threshold.

Aspect 15: The method of Aspect 14, wherein the trigger condition comprises detecting that the difference satisfies the difference threshold a number of times.

Aspect 16: The method of any one of Aspects-15, further comprising: receiving channel state information (CSI) report configuration information associated with a periodic or semi-persistent CSI report, wherein the CSI report configuration information indicates the trigger condition.

Aspect 17: The method of Aspect 16, further comprising: receiving the CSI report configuration information using a radio resource control message.

Aspect 18: The method of Aspect 16 or Aspect 17, wherein the CSI report configuration information indicates to activate trigger condition reporting.

Aspect 19: The method of any one of Aspects 16-18, wherein the CSI report configuration information comprises a report quantity field that is set to a value that indicates to activate the trigger condition reporting.

Aspect 20: The method of any one of Aspects 16-19, wherein the CSI report configuration information comprises a channel measurement resource setting associated with the downlink reference signal.

Aspect 21: The method of any one of Aspects 16-20, wherein the CSI report configuration information indicates multiple trigger conditions associated with reporting the difference, and the method further comprises: receiving a medium access control (MAC) control element (CE) that indicates to activate trigger condition reporting based at least in part on one of the multiple trigger conditions, wherein the MAC CE specifies the one of the multiple trigger conditions.

Aspect 22: The method of any one of Aspects 16-21, wherein the CSI report configuration information indicates multiple trigger conditions associated with reporting the difference, wherein the multiple trigger conditions include the trigger condition, and the method further comprises: receiving downlink control information that indicates: the trigger condition; and activation of trigger condition reporting based at least in part on the trigger condition.

Aspect 23: The method of any one of Aspects 1-22, further comprising: receiving channel state information (CSI) report configuration information that indicates to activate an aperiodic CSI report, wherein the CSI report configuration information further indicates to activate trigger condition reporting by setting a report quantity field to a value that indicates to activate the trigger condition reporting.

Aspect 24: The method of Aspect 23, wherein the CSI report configuration information indicates the trigger condition based at least in part on an aperiodic CSI trigger state associated with the aperiodic CSI report.

Aspect 25: The method of any one of Aspects 1-24, wherein transmitting the detection indication further comprises: transmitting, as the detection indication, a bit that is set to a value explicitly defined to indicate that the trigger condition has been detected.

Aspect 26: The method of Aspect 25, further comprising: transmitting, with the detection indication, a UE-selected Type-D QCL source reference signal.

Aspect 27: The method of Aspect 25 or Aspect 26, further comprising: transmitting, with the detection indication, an indication of the difference.

Aspect 28: The method of any one of Aspects 1-27, wherein transmitting the detection indication further comprises: transmitting the detection indication implicitly by transmitting a request to increase a frequency of calculating a signal metric associated with a beam.

Aspect 29: The method of Aspect 28, wherein the trigger condition is based at least in part on a periodic or semi-persistent channel state information (CSI) report associated with a first periodicity, and wherein transmitting the request to increase the frequency further comprises: transmitting an indication of a second periodicity that is shorter than the first periodicity.

Aspect 30: The method of any one of Aspects 1-29, wherein transmitting the detection indication further comprises: conditionally transmitting the detection indication based at least in part on detecting the difference prior to a start time associated with transmission of the Type-D QCL source reference signal.

Aspect 31: The method of any one of Aspects 1-30, wherein transmitting the detection indication further comprises: transmitting the detection indication based at least in part on a medium access control (MAC) control element (CE).

Aspect 32: The method of Aspect 31, wherein transmitting the detection indication based at least in part on the MAC CE further comprises: using a reserved bit of a beam failure recovery MAC CE; or using a trigger condition MAC CE associated with reporting that the difference has been detected.

Aspect 33: The method of Aspect 31 or Aspect 32, further comprising: determining, based at least in part on a lack of uplink resources, to transmit a scheduling request for an uplink resource associated with transmitting the detection indication; transmitting the scheduling request for a physical uplink control channel resource; and receiving an indication of an uplink resource assignment, wherein transmitting the detection indication further comprises transmitting the detection indication based at least in part on the uplink resource assignment.

Aspect 34: The method of any one of Aspects 1-34, further comprising: transmitting capability information that indicates support for the trigger condition; and receiving an indication of the trigger condition based at least in part on transmitting the capability information.

Aspect 35: The method of Aspect 34, wherein the capability information indicates support for a standards-defined trigger condition.

Aspect 36: The method of Aspect 34, wherein the capability information indicates a supported time window associated with monitoring a set of downlink reference signals, and wherein the trigger condition is based at least in part on the supported time window.

Aspect 37: A method of wireless communication performed by a network node, comprising: transmitting a trigger condition associated with reporting a difference between a quality of a downlink reference signal and a quality of a Type-D quasi co-located (QCL) source reference signal associated with a physical downlink shared control channel (PDSCH); and receiving a detection indication associated with detecting the trigger condition.

Aspect 38: The method of Aspect 37, wherein transmitting the trigger condition associated with reporting the difference comprises: transmitting the trigger condition based at least in part on at least one of: a radio resource control (RRC) message, a medium access control (MAC) control element (CE), or downlink control information.

Aspect 39: The method of Aspect 37 or Aspect 38, wherein the downlink reference signal is included in a set of downlink reference signals, and wherein the trigger condition includes a pre-condition associated with receiving the set of downlink reference signals.

Aspect 40: The method of Aspect 39, wherein the set of downlink reference signals comprises at least one of: a first set of channel state information reference signals; or a second set of synchronization signal blocks.

Aspect 41: The method of Aspect 39 or Aspect 40, wherein the trigger condition comprises: generating at least one signal metric based at least in part on the set of reference signals, the generating occurring within a time window that occurs before: a first time associated with a start of the Type-D QCL source reference signal; or a second time associated with obtaining QCL information.

Aspect 42: The method of any one of Aspects 37-41, wherein the quality of the downlink reference signal is based at least in part on the at least one signal metric.

Aspect 43: The method of Aspect 42, wherein the at least one signal metric comprises: a reference signal received power signal metric, or a signal-to-interference-plus-noise-ratio signal metric.

Aspect 44: The method of any one of Aspects 41-43, wherein the time window is based at least in part on at least one of: a first number of symbols, a second number of slots, or a third number of milliseconds.

Aspect 45: The method of any one of Aspects 41-44, wherein the start of the Type-D QCL source reference signal is based at least in part on at least one of: a first number of symbols, a second number of slots, or a third number of milliseconds.

Aspect 46: The method of any one of Aspects 37-45, wherein the trigger condition comprises the difference between the quality associated with the downlink reference signal and the quality associated with the Type-D QCL source reference signal satisfying a difference threshold.

Aspect 47: The method of Aspect 46, wherein the trigger condition comprises detecting that the difference satisfies the difference threshold a number of times.

Aspect 48: The method of any one of Aspects 37-47, further comprising: transmitting channel state information (CSI) report configuration information associated with a periodic or semi-persistent CSI report, wherein the CSI report configuration information indicates the trigger condition.

Aspect 49: The method of Aspect 48, further comprising: transmitting the CSI report configuration information using a radio resource control message.

Aspect 50: The method of Aspect 48 or Aspect 49, wherein the CSI report configuration information indicates to activate trigger condition reporting.

Aspect 51: The method of any one of Aspects 48-50, wherein the CSI report configuration information comprises a report quantity field that is set to a value that indicates to activate the trigger condition reporting.

Aspect 52: The method of any one of Aspects 48-51, wherein the CSI report configuration information comprises a channel measurement resource setting associated with the downlink reference signal.

Aspect 53: The method of any one of Aspects 48-52, wherein the CSI report configuration information indicates multiple trigger conditions associated with reporting the difference, and the method further comprises: transmitting a medium access control (MAC) control element (CE) that indicates to activate trigger condition reporting based at least in part on one of the multiple trigger conditions, wherein the MAC CE specifies the one of the multiple trigger conditions.

Aspect 54: The method of any one of Aspects 48-53, wherein the CSI report configuration information indicates multiple trigger conditions associated with reporting the difference, wherein the multiple trigger conditions include the trigger condition, and the method further comprises: transmitting downlink control information that indicates: the trigger condition; and activation of trigger condition reporting based at least in part on the trigger condition.

Aspect 55: The method of any one of Aspects 37-54, further comprising: transmitting channel state information (CSI) report configuration information that indicates to activate an aperiodic CSI report, wherein the CSI report configuration information further indicates to activate trigger condition reporting by setting a report quantity field to a value that indicates to activate the trigger condition reporting.

Aspect 56: The method of Aspect 55, wherein the CSI report configuration information indicates the trigger condition based at least in part on an aperiodic CSI trigger state associated with the aperiodic CSI report.

Aspect 57: The method of any one of Aspects 37-56, wherein receiving the detection indication further comprises: receiving, as the detection indication, a bit that is set to a value explicitly defined to indicate that the trigger condition has been detected.

Aspect 58: The method of Aspect 57, further comprising: receiving, with the detection indication, a UE-selected Type-D QCL source reference signal.

Aspect 59: The method of Aspect 57 or Aspect 58, further comprising: receiving, with the detection indication, an indication of the difference.

Aspect 60: The method of any one of Aspects 37-59, wherein receiving the detection indication further comprises: receiving the detection indication implicitly by receiving a request to increase a frequency of calculating a signal metric associated with a beam.

Aspect 61: The method of Aspect 60, wherein the trigger condition is based at least in part on a periodic or semi-persistent channel state information (CSI) report associated with a first periodicity, and wherein receiving the request to increase the frequency further comprises: receiving an indication of a second periodicity that is shorter than the first periodicity.

Aspect 62: The method of any one of Aspects 37-61, wherein receiving the detection indication further comprises: receiving the detection indication based at least in part on a medium access control (MAC) control element (CE).

Aspect 63: The method of Aspect 62, wherein receiving the detection indication based at least in part on the MAC CE further comprises: receiving the detection indication in a reserved bit of a beam failure recovery MAC CE; or receiving a trigger condition MAC CE associated with reporting that the difference has been detected.

Aspect 64: The method of Aspect 62 or Aspect 63, further comprising: receiving a scheduling request for an uplink resource associated with transmitting the detection indication; and transmitting an indication of an uplink resource assignment, wherein receiving the detection indication further comprises receiving the detection indication based at least in part on the uplink resource assignment.

Aspect 65: The method of any one of Aspects 37-64, further comprising: receiving capability information that indicates support for the trigger condition; and transmitting an indication of the trigger condition based at least in part on receiving the capability information.

Aspect 66: The method of Aspect 65, wherein the capability information indicates support for a standards-defined trigger condition.

Aspect 67: The method of Aspect 65 or Aspect 66, wherein the capability information indicates a supported time window associated with monitoring a set of downlink reference signals, and wherein the trigger condition is based at least in part on the supported time window.

Aspect 68: An apparatus for wireless communication at a device, comprising a processor; memory coupled with the processor; and instructions stored in the memory and executable by the processor to cause the apparatus to perform the method of one or more of Aspects 1-36.

Aspect 69: An apparatus for wireless communication at a device, comprising a processor; memory coupled with the processor; and instructions stored in the memory and executable by the processor to cause the apparatus to perform the method of one or more of Aspects 37-67.

Aspect 70: A device for wireless communication, comprising a memory and one or more processors coupled to the memory, the one or more processors configured to perform the method of one or more of Aspects 1-36.

Aspect 71: A device for wireless communication, comprising a memory and one or more processors coupled to the memory, the one or more processors configured to perform the method of one or more of Aspects 37-67.

Aspect 72: An apparatus for wireless communication, comprising at least one means for performing the method of one or more of Aspects 1-36.

Aspect 73: An apparatus for wireless communication, comprising at least one means for performing the method of one or more of Aspects 37-67.

Aspect 74: A non-transitory computer-readable medium storing code for wireless communication, the code comprising instructions executable by a processor to perform the method of one or more of Aspects 1-36.

Aspect 75: A non-transitory computer-readable medium storing code for wireless communication, the code comprising instructions executable by a processor to perform the method of one or more of Aspects 37-67.

Aspect 76: A non-transitory computer-readable medium storing a set of instructions for wireless communication, the set of instructions comprising one or more instructions that, when executed by one or more processors of a device, cause the device to perform the method of one or more of Aspects 1-36.

Aspect 77: A non-transitory computer-readable medium storing a set of instructions for wireless communication, the set of instructions comprising one or more instructions that, when executed by one or more processors of a device, cause the device to perform the method of one or more of Aspects 37-67.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communication at a user equipment (UE), comprising:
a memory; and
one or more processors, coupled to the memory, configured to:
obtain a trigger condition associated with reporting a difference between a quality of a downlink reference signal and a quality of a Type-D quasi co-located (QCL) source reference signal associated with a physical downlink shared control channel (PDSCH); and
transmit, to a network node, a detection indication associated with detecting the trigger condition.

2. The apparatus of claim 1, wherein the downlink reference signal is included in a set of downlink reference signals, and
wherein the trigger condition includes a pre-condition associated with receiving the set of downlink reference signals.

3. The apparatus of claim 2, wherein the set of downlink reference signals comprises at least one of:
a first set of channel state information reference signals; or
a second set of synchronization signal blocks.

4. The apparatus of claim 2, wherein the one or more processors are further configured to:
generate, within a time window, least one signal metric based at least in part on the set of reference signals, the time window occurring before:
a first time associated with a start of the Type-D QCL source reference signal; or
a second time associated with obtaining QCL information.

5. The apparatus of claim 4, wherein the quality of the downlink reference signal is based at least in part on the at least one signal metric.

6. The apparatus of claim 1, wherein the trigger condition comprises the difference between the quality associated with the downlink reference signal and the quality associated with the Type-D QCL source reference signal satisfying a difference threshold.

7. The apparatus of claim 6, wherein the one or more processors are further configured to detect that the difference satisfies the difference threshold a number of times.

8. The apparatus of claim 1, wherein the one or more processors are further configured to:
receive channel state information (CSI) report configuration information associated with a periodic or semi-persistent CSI report, wherein the CSI report configuration information indicates the trigger condition.

9. The apparatus of claim 8, wherein the one or more processors are further configured to:
receive a medium access control (MAC) control element (CE) that indicates to activate trigger condition reporting based at least in part on one of multiple trigger conditions indicated by the CSI report configuration information, wherein the MAC CE specifies the one of the multiple trigger conditions.

10. The apparatus of claim 8, wherein the CSI report configuration information indicates multiple trigger conditions associated with reporting the difference, wherein the multiple trigger conditions include the trigger condition, and
wherein the one or more processors are further configured to:
receive downlink control information that indicates:
the trigger condition; and
activation of trigger condition reporting based at least in part on the trigger condition.

11. The apparatus of claim 1, wherein the one or more processors are further configured to:
receive channel state information (CSI) report configuration information that indicates to activate an aperiodic CSI report, wherein the CSI report configuration information further indicates to activate trigger condition reporting by setting a report quantity field to a value that indicates to activate the trigger condition reporting.

12. The apparatus of claim 1, wherein the one or more processors, to transmit the detection indication, are configured to:
transmit, as the detection indication, a bit that is set to a value explicitly defined to indicate that the trigger condition has been detected.

13. The apparatus of claim 12, wherein the one or more processors are further configured to:
transmit, with the detection indication, a UE-selected Type-D QCL source reference signal.

14. The apparatus of claim 1, wherein the one or more processors, to transmit the detection indication, are configured to:
transmit the detection indication implicitly by transmitting a request to increase a frequency of calculating a signal metric associated with a beam.

15. The apparatus of claim 1, wherein the one or more processors are further configured to:
determine, based at least in part on a lack of uplink resources, to transmit a scheduling request for an uplink resource associated with transmitting the detection indication;
transmit the scheduling request for a physical uplink control channel resource; and
receive an indication of an uplink resource assignment,
wherein the one or more processors, to transmit the detection indication, are configured to transmit the detection indication based at least in part on the uplink resource assignment.

16. An apparatus for wireless communication at a network node, comprising:
a memory; and
one or more processors, coupled to the memory, configured to:
transmit a trigger condition associated with reporting a difference between a quality of a downlink reference signal and a quality of a Type-D quasi co-located (QCL) source reference signal associated with a physical downlink shared control channel (PDSCH); and
receive a detection indication associated with detecting the trigger condition.

17. The apparatus of claim 16, wherein the downlink reference signal is included in a set of downlink reference signals, and
wherein the trigger condition includes a pre-condition associated with receiving the set of downlink reference signals.

18. The apparatus of claim 17, wherein the one or more processors are further configured to:
generate, within a time window, at least one signal metric based at least in part on the set of reference signals, the time window occurring before:
a first time associated with a start of the Type-D QCL source reference signal; or
a second time associated with obtaining QCL information.

19. The apparatus of claim 16, wherein the trigger condition comprises the difference between the quality associated with the downlink reference signal and the quality associated with the Type-D QCL source reference signal satisfying a difference threshold.

20. The apparatus of claim 16, wherein the one or more processors are further configured to:
transmit channel state information (CSI) report configuration information associated with a periodic or semi-persistent CSI report, wherein the CSI report configuration information indicates the trigger condition.

21. The apparatus of claim 20, wherein the CSI report configuration information comprises a report quantity field that is set to a value that indicates to activate the trigger condition reporting.

22. The apparatus of claim 20, wherein the one or more processors are further configured to:
transmit a medium access control (MAC) control element (CE) that indicates to activate trigger condition reporting based at least in part on one of multiple trigger conditions indicated by the CSI report configuration information, wherein the MAC CE specifies the one of the multiple trigger conditions.

23. The apparatus of claim 16, wherein the one or more processors, to receive the detection indication, are configured to:
receive, as the detection indication, a bit that is set to a value explicitly defined to indicate that the trigger condition has been detected.

24. The apparatus of claim 23, wherein the one or more processors are further configured to:
receive, with the detection indication, a UE-selected Type-D QCL source reference signal.

25. The apparatus of claim 16, wherein the one or more processors, to receive the detection indication, are configured to:
receive the detection indication based at least in part on a medium access control (MAC) control element (CE).

26. The apparatus of claim 16, wherein the one or more processors are further configured to:
receive capability information that indicates support for the trigger condition; and
transmit an indication of the trigger condition based at least in part on receiving the capability information.

27. A method of wireless communication performed by a user equipment (UE), comprising:
obtaining a trigger condition associated with reporting a difference between a quality of a downlink reference signal and a quality of a Type-D quasi co-located (QCL) source reference signal associated with a physical downlink shared control channel (PDSCH); and
transmitting, to a network node, a detection indication associated with detecting the trigger condition.

28. The method of claim 27, wherein the downlink reference signal is included in a set of downlink reference signals, and
wherein the trigger condition includes a pre-condition associated with receiving the set of downlink reference signals.

29. A method of wireless communication performed by a network node, comprising:
transmitting a trigger condition associated with reporting a difference between a quality of a downlink reference signal and a quality of a Type-D quasi co-located (QCL) source reference signal associated with a physical downlink shared control channel (PDSCH); and
receiving a detection indication associated with detecting the trigger condition.

30. The method of claim 29, wherein receiving the detection indication further comprises:
receiving, as the detection indication, a bit that is set to a value explicitly defined to indicate that the trigger condition has been detected.
